(19) United States
(12) Patent Application Publication
(10) Pub. No.: US 2008/0034861 A1
(43) Pub. Date: Feb. 14, 2008

(54) MULTIPLE-MODE HEATED SEMICONDUCTOR ANEMOMETER

(75) Inventor: John A. Bognar, Belgrade, MT (US)

Correspondence Address: SHERIDAN ROSS PC, 1560 BROADWAY, SUITE 1200, DENVER, CO, 80202, US

(73) Assignee: ANASPHERE, INC., Bozeman, MT (US)

(21) Appl. No.: 11/837,281

(22) Filed: Aug. 10, 2007

Related U.S. Application Data
(60) Provisional application No. 60/837,436, filed on Aug. 11, 2006.

(51) Int. Cl. G01F 1/68

(52) U.S. Cl. 73/204.19

(57) ABSTRACT

The present invention is directed toward a circuit that employs heated semiconductor elements to sense fluid flow speed and direction based on the cooling of the semiconductor element. The fluid flow speed and direction is determined by measuring the changes in the forward voltage drop across the semiconductor. The present invention improves on the previous art by enabling a single circuit to operate in either a constant-current or hybrid (constant-current/constant-temperature) mode where advantageous aspects of both modes are employed.

### CROSS REFERENCE TO RELATED APPLICATIONS

This Application claims the benefit of U.S. Provisional Application No. 60/837,436, filed Aug. 11, 2006, the entire disclosure of which is hereby incorporated herein by reference.

### FIELD

The present invention is directed to sensing devices and more particularly to a flow sensor or an anemometer that can be used to measure wind speed and direction.

### BACKGROUND

Surface-based meteorological stations may be used in connection with monitoring a variety of environmental conditions. In connection with surface-based meteorological stations, it is often desirable to measure the speed and direction of the wind. Anemometers often take advantage of the relationship between heat dissipation and air speed. The principle of thermal anemometry relies on King's Law, which shows that the power required to maintain a fixed differential between the surface of a heated sensor and the ambient air temperature increases as the square root of air speed.

Hot wire anemometers were first employed to exploit this phenomenon. One disadvantage of hot wire anemometers is the fact that they rely on metallic filaments that are fragile and unreliable. Because of this, anemometers have evolved that replace the fragile metallic filaments of hot wire anemometers with bipolar transistors and the like. By carefully controlling the amount of power supplied to a bipolar transistor in an air stream, it is possible to still exploit King's Law to determine wind speed. Two basic types of circuits have come about through this evolution. The first type of circuit is known as a constant temperature anemometer (CTA) and the second type of circuit is known as a constant power anemometer (CPA). CTAs generally employ a solid-state feedback control circuit to maintain a constant temperature difference between the heated sensor and the fluid temperature as measured by a second sensor. CTAs enable the measurement of fast-changing velocity fluctuations. However, one major drawback to classical CTAs is that they consume a significant amount of power, making their use in remote locations less desirable.

CPAs, on the other hand, consume much less power than their CTA counterparts, thereby making them a promising circuit for remote anemometer applications. CPAs provide constant electrical power to a resistance element. A temperature sensor is attached to the heater element and is heated by conduction from the heater element. The difference between the temperature of the heated sensor and an ambient fluid temperature sensor is measured and the fluid velocity is determined. If the difference in temperature is small, then the fluid velocity is high. Conversely, if the temperature difference is large, then the fluid velocity is low. CPAs are not without their own drawbacks. For example, CPAs are slow to respond to changes in velocity and temperature due to the thermal inertia of the sensors and, unless specifically corrected, they have a limited range of temperature compensation.

It would be desirable to have an anemometer circuit that offers the advantages of both the CPA and the CTA circuits. More specifically, it would be desirable to have an anemometer circuit that is capable of operating in a wide range of temperatures, responds to quick changes in fluid velocity, and is a relatively efficient user of power.

### SUMMARY

The present invention is directed to solving these and other problems and disadvantages of the prior art. Embodiments of the present invention provide a device for sensing flow rate of a fluid medium. In accordance with embodiments of the present invention, the device comprises a current source, a sensor device, a controller, and an analog to digital converter. The sensor device is exposed to a flow of the material, and is interconnected to the current source. The controller may control the current source to supply a selected amount of current to the sensor device. In accordance with at least one embodiment of the present invention, the selected amount of current is a constant and a temperature of the sensor device varies with at least a rate of the flow of material. The voltage drop across the sensor device varies with the temperature of the sensor device and a signal indicative of the voltage drop across the sensor device is provided to the controller.

A device according to embodiments of the present invention comprises a circuit that can operate in a constant-current mode. In the constant-current mode, a constant current is set in the sensor device. The voltage drop across the sensor device changes slightly with temperature/fluid flow. From the relationship P=VI, it follows that if current is fixed, and voltage drop varies, the power will vary.

Additionally, a device according to embodiments of the present invention may utilize the single circuit in either a constant-power mode, a constant-temperature mode, or a hybrid mode combining aspects of both of these modes. In the hybrid mode, a level of power may be applied to the sensor device such that its temperature lies within a certain predefined window. In such a case, the power is adjusted (as in a constant-temperature system) until the temperature of the sensor is within the desired window. Once the temperature of the sensor is within the desired window, the current supplied to the sensor device is held constant. The circuit, particularly in the hybrid mode, can keep the voltage drops of the sensor device in ranges such that lookup tables or comparatively simple math may be used to transform the voltage drop measurements into wind speed measurements.

Another aspect of the present invention is the ability to control power consumption by the flow sensing device. More particularly, a control voltage can be applied in the circuit to control the power delivered to the sensor device. By reducing or zeroing this control voltage via the controller, it is possible to turn off the circuit, thereby reducing its power consumption.

In accordance with still further embodiments of the present invention, a method for sensing a flow rate of a medium is provided. The method generally comprises exposing a flow sensor device to an ambient flow of a medium and supplying a constant current to the flow sensor device. A voltage drop across the flow sensor device is determined while continuing to supply the constant current to the flow sensor device. The amount of the voltage drop is a function of the temperature of the sensor device, and is indicative of the flow rate of the medium. As sensing continues, the constant current continues to be supplied to the sensor device, and the temperature of the sensor device is allowed to vary with at least a rate of ambient flow of the medium.

Additional advantages of the present invention will become readily apparent from the following description, particularly when taken together with the accompanying drawings.

### BRIEF DESCRIPTION OF THE DRAWINGS

FIG. 1 depicts an anemometer in accordance with embodiments of the present invention;

FIG. 2A depicts a cross-sectional top view of the anemometer components in a first configuration in accordance with embodiments of the present invention;

FIG. 2B depicts a cross-sectional top view of the anemometer components in a second configuration in accordance with embodiments of the present invention;

FIG. 3 is a schematic diagram of a circuit used to sense fluid flow in accordance with embodiments of the present invention;

FIG. 4 is a schematic diagram of a circuit used to sense fluid flow in accordance with other embodiments of the present invention;

FIG. 5 is a schematic diagram of a circuit used to sense fluid flow in accordance with other embodiments of the present invention;

FIG. 6 is a schematic diagram of a circuit used to sense fluid flow in accordance with other embodiments of the present invention;

FIG. 7 is a flow diagram depicting a method of measuring fluid flow in accordance with embodiments of the present invention; and

FIG. 8 is a flow diagram depicting a method of operating a fluid flow sensing system in a hybrid mode in accordance with embodiments of the present invention.

### DETAILED DESCRIPTION

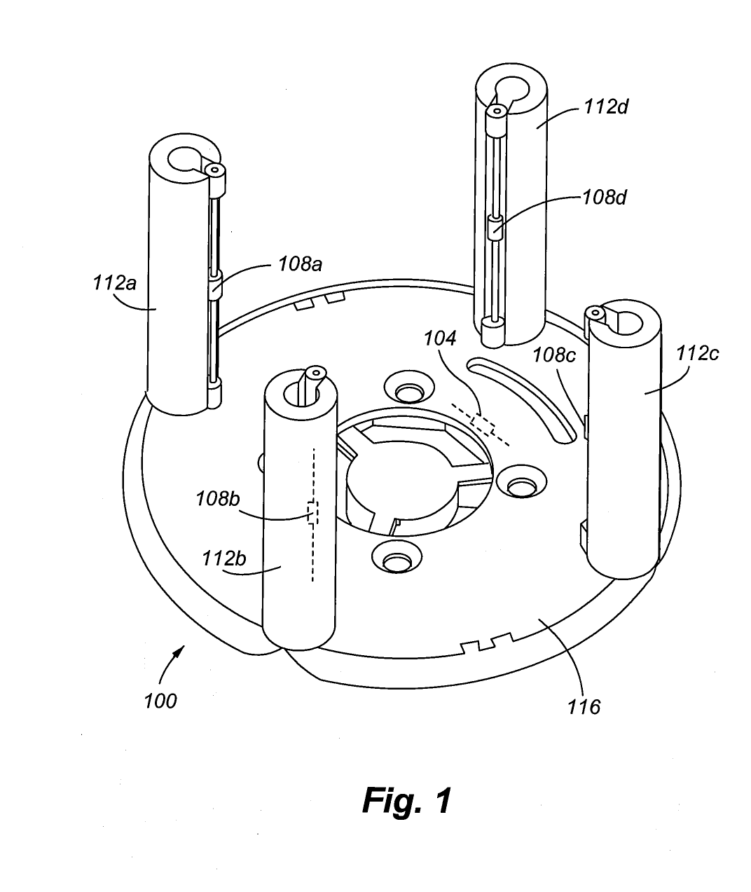

With reference now to FIG. 1, an anemometer system 100 is depicted in accordance with at least some embodiments of the present invention. The anemometer system 100 may be deployed in weather stations, other meteorological sensor systems, and devices which can be used to measure the flow of various fluids such as water, air, and other gases. The anemometer system 100 may comprise a first or reference sensor device 104 and a plurality of second or flow sensor devices 108a-d. The reference sensor device 104 is depicted as being housed within a base plate 116 of the anemometer system 100 such that the reference sensor device 104 is protected from the fluid flow conditions. The base plate 116 serves as at least a portion of a flow shield that blocks all of the ambient fluid flow with respect to the reference sensor device 104. By blocking all of the ambient fluid flow to the reference sensor device 104, the reference sensor device 104 can be used to determine a zero-flow response at the ambient temperature of the fluid within which the anemometer system 100 is immersed.

In accordance with at least one alternative embodiment of the present invention, the reference sensor device 104 may be located remotely with respect to the anemometer system 100. More specifically, the reference sensor device 104 may not even be associated with a flow shield such as the base plate 116. Rather, the reference sensor device 104 may be in a completely separate area that is not subject to the fluid flow.

The flow sensor devices 108a-d are housed in support structures 112a-d respectively that serve as fluid flow shields for the flow sensor devices 108a-d. The support structures 112a-d are depicted as being oriented uniformly around the circumference of the base plate 116 such that the fluid flow from a certain direction in the plane of the base plate 116 is at least partially blocked from reaching a flow sensor device 108 by its support structure 112. As can be appreciated by one skilled in the art, the configuration of the flow sensor devices 108 relative to one another may be adjusted both within their plane and out of plane with respect to one another without departing from the inventive aspects of the present invention.

By partially blocking the flow in different directions to a flow sensor device 108, information regarding a direction of the fluid flow relative to the anemometer system 100 can be obtained from taking differences between the temperatures of the various flow sensor devices 108. A known algorithm may be employed to determine fluid flow direction.

Although the anemometer system 100 is depicted as having four flow sensor devices 108, one skilled in the art will appreciate that a greater or lesser number of flow sensor devices 108 may be employed to determine fluid flow speed and direction. In the most degenerate case, a single flow sensor device 108 may be used to determine fluid flow speed. In another embodiment, two flow sensor devices 108 may be used to determine fluid flow speed and fluid flow direction relative to a single axis. In still another embodiment, three flow sensor devices 108 may be employed to determine fluid flow speed and fluid flow direction relative to two axes. A greater number of flow sensor devices 108 may be employed for redundancy and to increase the accuracy with which fluid flow direction and speed can be determined. In addition, shielded and unshielded flow sensor devices 108 can be used in combination.

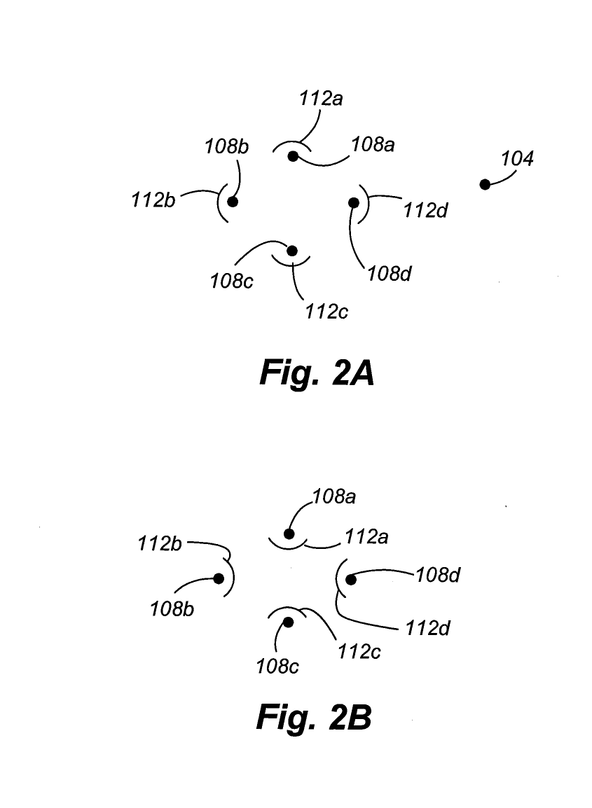

FIG. 2A depicts a first possible orientation of four flow sensor devices 108a-d as seen from above the anemometer system 100. The four flow sensor devices 108a-d may be located along a common circular circumference in 90 degree increments from one another. The reference sensor device 104 may be located remotely from the flow sensor devices 108 in order to obtain ambient temperature measurements. Each flow sensor device 108 is blocked by a support structure 112. The support structure 112 associated with each flow sensor device 108 outwardly blocks fluid flow from reaching the flow sensor device 108. Accordingly, each flow sensor device 108 will be exposed to a fluid flow from a different direction. For example, the upper most flow sensor device 108a would be fully exposed to a fluid flowing upward in the diagram of FIG. 2A while the lower most flow sensor device 108c would be completely shielded from the same flow. The other two flow sensor devices 108b and 108d would be partially exposed to the same fluid flow in the upward direction. The differences in exposure to the same fluid flow can be exploited to determine a fluid flow speed and direction.

FIG. 2B depicts a second possible orientation of four flow sensor devices 108a-d as seen from above the anemometer system 100. In this particular configuration, the flow sensor devices 108a-d are still located along a common circular circumference in 90 degree increments from one another and the reference sensor device 104 may still be remotely located from the anemometer system 100. However, in this configuration of flow sensor devices 108a-d, each support structure 112 may inwardly block fluid flow from reaching its associated flow sensor device 108. Thus, each flow sensor device 108 will be exposed to a fluid flow from a different direction. For example, the upper most flow sensor device 108a would be fully exposed to a fluid flowing downward in the diagram of FIG. 2B while the lower most flow sensor device 108c would be completely shielded from the same flow. The other two flow sensor devices 108b and 108d would be partially exposed to the same fluid flow in the upward direction. Again, the differences in exposure to the same fluid flow can be exploited to determine the speed and direction of the fluid flow.

The flow sensor devices 108a-d can also be spaced apart in a non-uniform fashion around a common circumference. Such a configuration of flow sensor devices 108a-d may be useful in applications where fluid flow direction is considered less important to determine and fluid flow distribution (e.g., fluid flow dynamics in a pipe or the like) is of more interest.

In addition, an unshielded flow sensor device 108 may be provided for sensing fluid flow speed only. An embodiment of the anemometer system 100 may provide an unshielded flow sensor device 108 in addition to partially shielded flow sensor devices 108. The combination of unshielded and partially shielded flow sensor devices 108 can be used to provide information regarding the fluid velocity (i.e., speed and direction).

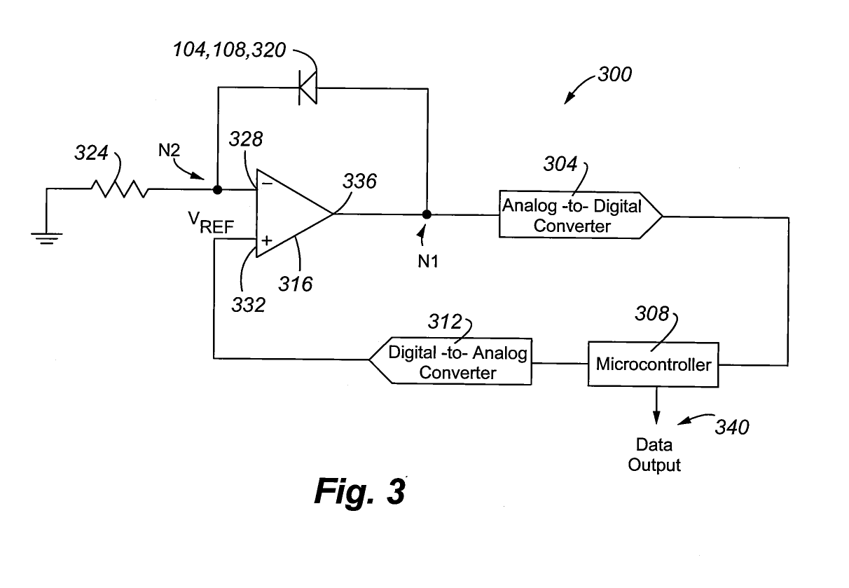

FIG. 3 is a circuit schematic depicting a circuit 300 that may be employed in connection with the anemometer system 100 in accordance with embodiments of the present invention. The circuit 300 comprises an operational amplifier 316 having an inverting 328 and non-inverting 332 inputs and an output 336. The operational amplifier 316 acts as a current source for the circuit 300. The output of the operational amplifier 316 is connected to an anode side of a first diode 320 as well as the input of an analog-to-digital converter 304 via a first node N1. The first diode 320 is an example of a sensor device 104, 108 that may be employed in accordance with embodiments of the present invention. The first diode 320 may comprise a typical pnjunction diode that conducts positive current (i.e., current flowing from the anode of the first diode 320 to the cathode of the first diode 320). In accordance with at least one embodiment of the present invention, the first diode 320 may comprise a silicon diode that has an average 0.6 V drop across it while conducting. The voltage across the first diode 320 (e.g., the potential difference between the anode and cathode side of the first diode 320) may change with temperature. For example, the voltage drop across the first diode 320 may change at a rate of approximately 0.2 mV per degree Celsius change in temperature about the first diode 320. Knowing the characteristics of the first diode 320 and its responsiveness to changes in temperature, it is possible to determine a temperature change and therefore a fluid flow speed relative to the diode 320 upon observation of a voltage change across the first diode 320.

Although the sensor device 104, 108 is depicted and described as a diode, other semiconductor devices may be employed as sensor devices 104, 108. One example of a semiconductor device that may be employed in lieu of the first diode 320 is a transistor, such as a bipolar junction transistor. Another example of a semiconductor device that may be employed is a Zener diode that conducts current when a reverse voltage is applied thereto. In addition, non-semiconductor devices may be used as sensor devices 104, 108. For example, the sensor devices 104, 108 may comprise common resistors or thermistors.

The cathode side of the first diode 320 is connected to the inverting input 328 of the operational amplifier 316 at a second node N2. Also connected to the second node N2 is a first resistor 324. The opposite side of the first resistor 324 is connected to a common voltage point, such as ground. Generally speaking, however, the common voltage point may comprise any potential that is lower than can be output from the operational amplifier's 316 output.

The output of the analog-to-digital converter 304 is connected to the input of a microcontroller 308. The output of the microcontroller 308 is connected to a digital-to-analog converter 312 that converts the digital output of the microcontroller 308 back into an analog wave form or signal suitable as an input to the non-inverting input 332 of the operational amplifier 316. As can be appreciated by one skilled in the art, the analog-to-digital converter 304 and/or the digital-to-analog converter 312 may be internally located within the microcontroller 308.

The microcontroller 308 is adapted to read the output of the operational amplifier 316 via the analog-to-digital converter 304 and determine the voltage drop across the first diode 320. The voltage drop across the first diode 320 is output at a data output 340, which provides a signal that can be converted into a temperature of the sensor and thus a flow rate of an ambient fluid. Alternatively, the microcontroller 308 may convert the voltage readings into temperature values and output the temperature values and provide signals indicative of the measured temperature values at the data output 340. As still another example, the controller 308 can calculate the rate of fluid flow and provide that information at the data output 340.

The voltage at the output 336 of the operational amplifier 316 (i. e., the voltage at the first node N1) is equal to the summation of the voltage at the non-inverting input 332 V_{REF} and the voltage drop across the first diode 320. Based on this relationship, the microcontroller 308 is able to determine the voltage drop across the first diode 320 by determining the difference between the output 336 voltage of the operational amplifier 316 and the known voltage at the non-inverting input 332 V_{REF}. In a constant-current mode of operation, the variable voltage drop across the first diode 320 is used to determine fluid flow speed, whereas in a constant-temperature mode of operation, the difference between the output voltage 336 and V_{REF} is held constant and the variations of V_{REF} are used to determine fluid flow speed.

The microcontroller 308 also acts to control the voltage applied to the non-inverting input 332 of the operational amplifier 316 (i.e., V_{REF}). In accordance with embodiments of the present invention, in a constant-current mode of operation, the microcontroller 308 maintains the voltage V_{REF} at a constant value to maintain a constant current at the output 336 of the operational amplifier 316. By maintaining a constant voltage at the non-inverting input 332, the voltage at the inverting input 328 (i.e., V_{N2}) also remains constant. Because the voltage at the non-inverting input 332 is held constant and because the value of the first resistor 324 is a fixed value, the current through the first resistor 324 is maintained at a constant value. This causes a constant current to be provided to the first diode 320. This constant-current mode of operation differs from the operation of previous CPAs in that current through the first resistor 324 is maintained at a constant value, instead of maintaining the power dissipated by the circuit elements at a constant value.

The forward voltage drop of the first diode 320 varies as the temperature about and/or flow of fluid past the first diode 320 changes. The voltage at the output 336 of the operational amplifier 316 varies in response to these resistance changes of the first diode 320 since the value of both voltage inputs and thus the current output by the operational amplifier 316 remain the same. The microcontroller 308 receives at its input the value of the output voltage 336 of the operational amplifier 316, knows the digital-to-analog converter 312 output voltage V_{REF}, and from these known values determines the voltage drop across the first diode 320. The voltage drop across the first diode 320 can then be correlated to a fluid temperature or rate of fluid flow.

In accordance with other embodiments of the present invention, the microcontroller 308 may operate the circuit 300 in a constant-temperature mode. In a constant-temperature mode of operation, the microcontroller 308 adjusts the current output by the operational amplifier 316 to keep the first diode 320 at a desired temperature. By keeping the first diode 320 at a constant temperature, the forward voltage drop of the first diode 320 remains constant. The fluctuations in power required to maintain this temperature, measured via changes in V_{REF}, are used to determine the fluid flow speed across the first diode 320.

In accordance with still other embodiments of the present invention, the microcontroller 308 may operate the circuit 300 in a hybrid mode. In the hybrid mode of operation, the microcontroller 308 causes the first diode 320 to be operated within a predetermined temperature window and maintains a constant current through the first diode 320. The microcontroller 308 may selectively and dynamically change the operational mode of the circuit 300 depending upon the changes in conditions about the circuit such as temperature and fluid flow speed without having to change any configuration of circuit 300 elements.

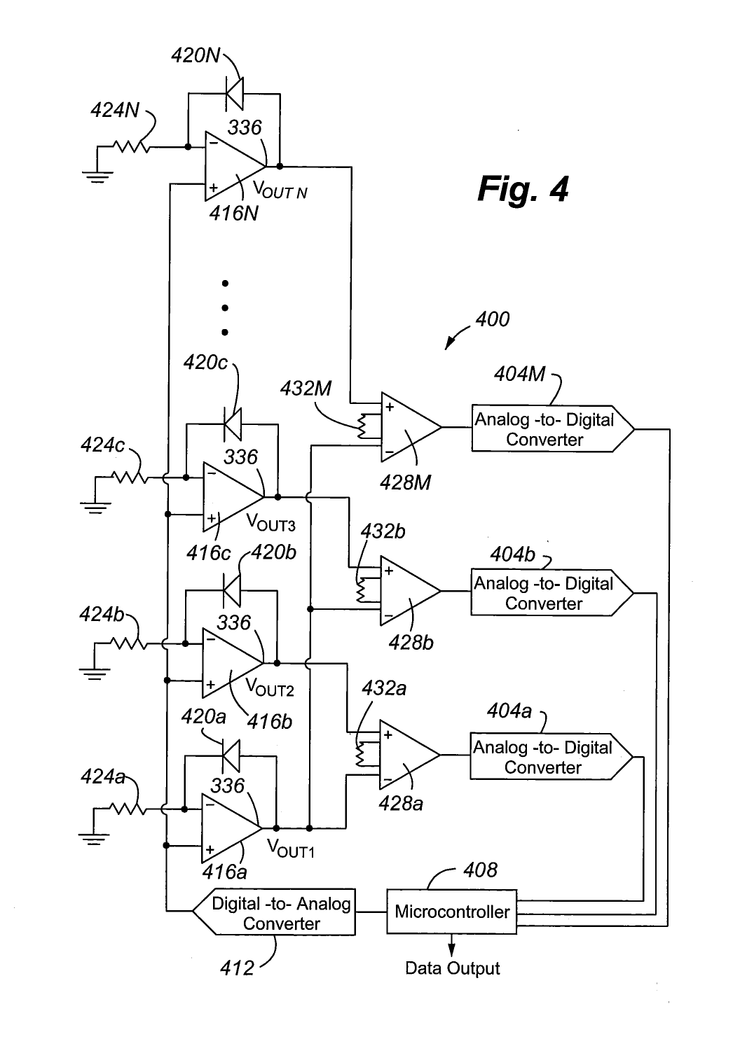

FIG. 4 depicts a circuit 400 that may be employed in connection with the anemometer system 100 in accordance with embodiments of the present invention. The circuit 400 comprises a plurality of operational amplifiers 416a to 416N and a plurality of instrumentation amplifiers 428a to 428M. A first set of the operational amplifiers 416a to 416N may be used as current sources to the circuit 400, while a second set of the instrumentation amplifiers 428a to 428M provide an output based on a voltage difference between their inputs.

The number of source operational amplifiers 416 in the first set (ie., N) may be greater than or equal to two, while the number of instrumentation operational amplifiers 428 in the second set (i.e. M) is equal to N−1, where N and M are both integers. A first set of resistors 424a to 424N are provided, each corresponding to a source operational amplifier in the first set of operational amplifiers 416a to 416N. These resistors 424 are used to control the current flowing through the diodes 420a to 420N. The voltage applied across each resistor 424a to 424N is substantially the same. The values of the resistors 424a to 424N are substantially the same, thereby allowing the same constant current to be provided therethrough. Therefore, in a constant-current mode of operation, the same current is provided to each of the diodes 420a to 420N. By providing the same amount of current to the reference sensor 104 as the flow sensors 108, the reference sensor 104 can be used to provide a baseline voltage drop for the ambient fluid temperature while voltage drop across the flow sensors 108 will reflect the fluid flow in addition to fluid temperature. Accordingly, the difference between the voltage drop across a flow sensor 108 and the voltage drop across the reference sensor 104 will be indicative of the fluid flow.

Additionally, a second set of resistors 432a to 432M are provided, each corresponding to an instrumentation amplifier in the second set of operational amplifiers 428a to 428M. The resistors 432a to 432M are used to set the gain of each instrumentation amplifier 428a to 428M.

The circuit 400 operates in a similar fashion to the circuit 300 depicted in FIG. 3, whereby the voltage drop across the diodes 420a to 420N are used to determine fluid temperature and subsequently fluid flow speed. The difference in the second circuit 400 is that output differentials between various diodes 420b to 420N are compared to an output of a reference diode 420a. The reference diode 420a may correspond to a reference sensor device 104 that is shielded from the fluid flow and provides a reading of zero-flow rate at the ambient fluid temperature. The other diodes 420b to 420N may correspond to one of the flow sensor devices 108 that are open to the flow of the fluid. The output 336 of the first operational amplifier 416a (i.e., V_{OUT1}) is supplied to an inverting input of each instrumentation operational amplifier 428a to 428M. The outputs 336 of the other operational amplifiers 416b to 416N (i.e., V_{OUT2}, V_{OUT3}, V_{OUTN}) are supplied to the non-inverting input of each instrumentation amplifier 428a to 428M.

The instrumentation amplifiers 428a to 428M provide, as an output, the difference between the voltage across the reference diode 420a and the voltage across each corresponding diode 420b to 420N; this difference is multiplied by a gain factor related to the value of resistor 432. For example, the second instrumentation amplifier 428b provides, as an output, an amplified difference between V_{OUT3} and V_{OUT1}. As such, the ambient temperature is accounted for in the output of the instrumentation amplifiers 428a to 428M, which are then provided to the input of a corresponding analog-to-digital converter 404a to 404M and subsequently to the microcontroller 408 as input.

In accordance with embodiments of the present invention, the outputs of each analog-to-digital converter 404a to 404M are supplied to the microcontroller 408 in separate data paths as depicted. However, in accordance with alternative embodiments of the present invention, the outputs of the each analog-to-digital converter 404a to 404M may be provided to the microcontroller 408 via a common data bus where the outputs of each converter 404a to 404M maintain a logical separation on the bus but are otherwise provided to the microcontroller 408 over the same input port or channel. As can be appreciated by one skilled in the art, analog-to-digital converters with multiple input channels could replace the single channel analog-to-digital converters shown.

The microcontroller 408 outputs the data received from each instrumentation amplifier 428a to 428M. The microcontroller 408 also ensures that a substantially constant voltage is applied to each non-inverting input of the source operational amplifiers 416a-N in the constant-current and hybrid mode of operation. Since the microcontroller 408 knows and controls the input to each operational amplifier 416a to 416N and knows the output voltage at each instrumentation operational amplifier 428a to 428M, the microcontroller 408 can determine the voltage drop across each diode 420a to 420N due to fluid flow, all while maintaining a constant current through each resistor 424a to 424N.

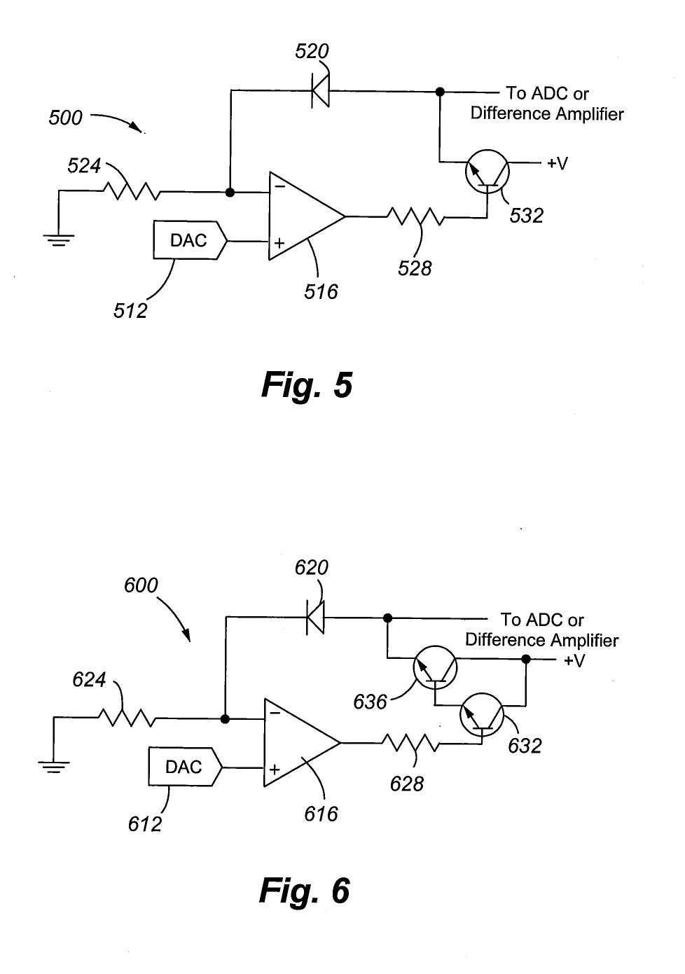

FIG. 5 is a schematic diagram of another circuit 500 that may be employed in connection with the anemometer system 100 in accordance with embodiments of the present invention. The circuit 500 is similar to circuits 300 or 400 except that it includes a transistor 532 and a second resistor 528 that amplify the output of the operational amplifier 516. The transistor 532 may include any type of transistor such as a pnp or npn bipolar junction transistor, Darlington transistor, or field-effect transistor. In accordance with a preferred embodiment, the transistor 532 comprises an npn bipolar junction transistor.

The operational amplifier 516 produces the same output as before, namely the reference voltage output by the digital-to-analog converter 512 plus the voltage drop across the first diode 520. The second resistor 528 is connected to the output of the operational amplifier 516, which in turn is connected to the base region of the transistor 532. The collector region of the transistor 532 may be connected to a voltage source +V that helps boost the signal output at the emitter region. The output at the transistor 532 emitter region is supplied to an analog-to-digital converter as in FIG. 3 or to an instrumentation amplifier 428a to 428M as in FIG. 4. The rest of circuit 500 is essentially identical to either the first circuit 300 or second circuit 400. Namely, the non-inverting input of the operational amplifier 516 is connected to the output of the first diode or other sensor device 520 and an input of the first resistor 524.

FIG. 6 is a schematic diagram of yet another circuit 600 that may be employed in connection with the anemometer system 100 in accordance with embodiments of the present invention. The circuit 600 is almost identical to circuit 500 except that it includes a second transistor 636 that further amplifies the output of the first transistor 632. The second transistor 636 may include any type of known semiconductor transistor such as a pnp or npn bipolar junction transistor, Darlington transistor, or field-effect transistor. In accordance with a preferred embodiment, both the first transistor 632 and second transistor 636 comprise an npn bipolar junction transistor.

The operational amplifier 616 produces the same output as before, namely the reference voltage output by the digital-to-analog converter 612 plus the voltage drop across the first diode 620. The second resistor 628 is connected to the output of the operational amplifier 616, which in turn is connected to the base region of the first transistor 632. The collector region of the first transistor 632 may be connected to a voltage source +V that helps boost the signal output at the emitter region. The output at the first transistor 632 emitter region is supplied to the base region of the second transistor 636. The collector region of the second transistor 636 may be connected to another voltage source +V that further boosts the signal output at the emitter region. The source voltage +V supplied to the second transistor 636 may be the same as the source voltage +V supplied to the first transistor 632, although such a configuration is not required. For example, the first transistor 632 may be supplied with a source voltage +V of a first amount while the second transistor 636 may be supplied with a source voltage +V of a second different amount. The output of the second transistor 636 is supplied to an analog-to-digital converter as in FIG. 3 or to an instrumentation amplifier 428a to 428M as in FIG. 4. The use of transistors 632 and 636 to boost the operational amplifier 616 output is advantageous since the operational amplifier alone may deliver insufficient current to adequately heat the sensor device or maintain equality between the voltages present at the non-inverting and inverting inputs.

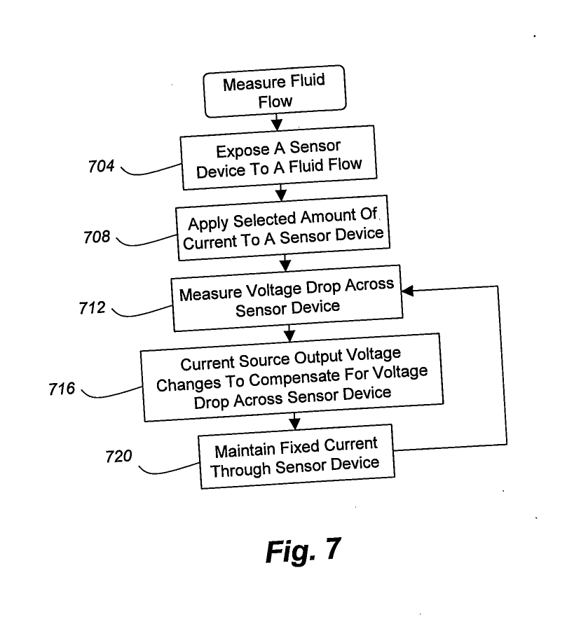

FIG. 7 is a flow chart depicting a method of measuring fluid flow in accordance with at least some embodiments of the present invention. The method begins when a sensor device 108 is exposed to a fluid flow (step 704). Of course, more than one sensor device 108 may be exposed to the same fluid flow but in a different position and/or orientation. As can be appreciated by one skilled in the art, another sensor device 104 may be immersed within the same fluid but protected from the flow to provide a base reading of the fluid's ambient temperature.

While the sensor device 108 is exposed to the fluid flow, a selected amount of current is supplied to the sensor device 108 (step 708). The amount of current supplied to the sensor device 108 may be selected depending upon the type of fluid, the type of sensor device 108 employed, the ambient temperature of the fluid, and the optimal temperature operating range of the sensor device 108. The selected amount of current is supplied to the sensor device 108 via a current source such as an operational amplifier. The amount of current provided to the sensor device 108 may be selected based on a trial-and-error basis where a first current amount is supplied to the sensor device 108 and the reaction of the sensor device 108 (e.g., the voltage drop across the sensor device 108) to the first amount of current is determined, then a second current amount is supplied to the sensor device 108 and the reaction of the sensor device 108 to the second amount of current is determined and based on the comparison of the reactions one of the two current amounts, or some third current amount, is selected as the current that will be provided to the sensor device 108 during the constant-current mode of operation. In another embodiment, the amount of current provided to the sensor device 108 may be determined a priori based on temperature of the fluid about the sensor device 108.

The current supplied by the current source is controlled by the amount of voltage applied to the current source (e.g., V_{REF}). In accordance with embodiments of the present invention, a controller such as the microcontroller 308, 408 may maintain the voltage applied to the current source at a constant value, thereby ensuring the amount of voltage supplied at the current source's inverting input is also constant.

The voltage drop across the sensor device 108 is measured while the selected amount of current is supplied to the sensor device 108 (step 712). The voltage drop across the sensor device 108 is determined by monitoring the voltage at the output of the current source. In particular, the voltage drop across the sensor device 108 is monitored to determine the changes in voltage and subsequently the changes in temperature of the sensor. Based on the changes in temperature of the sensor device 108 the fluid flow may be determined by the controller 308, 408. As the voltage across the sensor device 108 changes in response to temperature and flow changes, the voltage output of the current source changes.

The changes in voltage across the sensor device 108 are monitored by the controller 308, 408, and in response to such changes, the voltage supplied at the output of the current source adjusts to compensate (step 716). The current source compensates for the changes in voltage across the sensor device 108 to maintain a constant current through the fixed resistance and therefore a constant current through the sensor device 108 (step 720). If the current through the sensor device 108 is maintained at a constant level, then any changes in resistance due to temperature changes will result directly in voltage changes. The voltage changes across the sensor device 108 can be used to determine temperature changes and thus fluid flow rate. The method then returns to step 712 to continue measurement of the voltage drop across the sensor device 108.

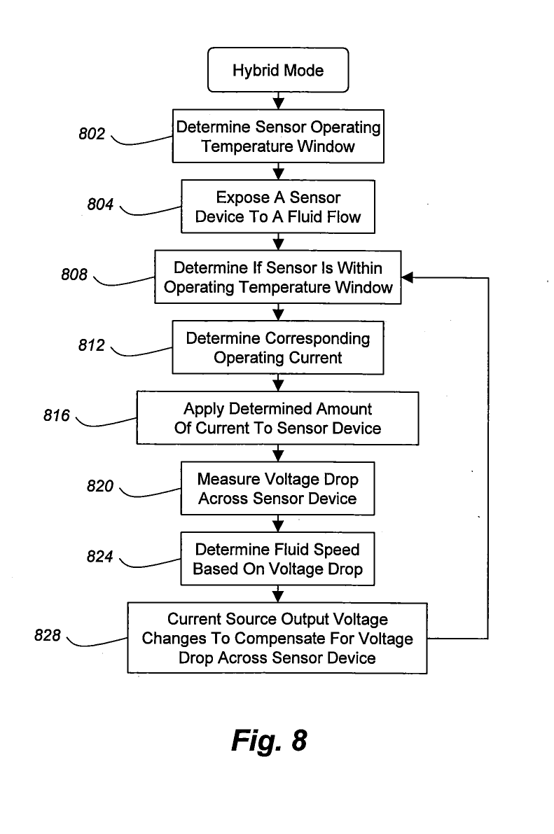

FIG. 8 is a flow chart depicting a method of operating an anemometer system 100 in a hybrid mode (e.g., a combination of constant-temperature and constant-current mode) without changing the physical circuitry of the anemometer system 100 in accordance with at least some embodiments of the present invention. The method begins by selecting a desired operating temperature window for the sensor device 108 (step 802). The operating temperature window may be selected based on the expected average temperature of the fluid, the expected average speed of the fluid flow, and the type of the sensor device 108. The operating temperature window is selected to maintain the sensor device 108 within a predetermined resistance and voltage drop.

A sensor device 108 is then exposed to a fluid flow (step 804). As noted above, multiple sensor devices 108 may be exposed to the fluid flow. Furthermore, another sensor device 104 may be immersed in the fluid but completely protected from the fluid flow.

Next, the amount of current required to maintain the sensor device 108 within the temperature window is determined (step 812). The operating current required to maintain the sensor device 108 within the predetermined temperature window will also vary based upon the type of sensor device 108 employed. Knowing the value of the fixed resistance 324, 424 used to maintain a constant current and the desired power, the desired amount of current can be determined.

The amount of current provided to the sensor device 108 will also vary based on the environment in which the anemometer system 100 is employed. Advantageously, the use of different temperature windows can be employed such that a single circuit can be utilized in a number of different situations without requiring the reconfiguration of the circuit or replacement of circuit elements.

Once the proper operating current has been selected, the determined amount of current is supplied to the sensor device 108 via a current source (step 816). A controller 308, 408 sets the amount of voltage provided to the non-inverting input of the current source, which in turn sets the amount of power and current provided to the sensor device 108. As fluid flows past the sensor device 108 heat is removed from the sensor device 108, thereby changing the internal resistance or forward voltage across the sensor device 108 and dissipating power in the form of heat. As long as the sensor device 108 is maintained in the temperature window, the current supplied to the sensor device 108 does not vary. If the temperature of the sensor device 108 falls outside of the predetermined temperature window, then a new current will have to be selected.

While controlling the current source, the controller 308, 408 also measures the voltage drop across the sensor device 108 (step 820). The voltage drop across the sensor device 108 may be determined with a direct measurement or by measuring the output voltage of the current source and subtracting the voltage supplied to the current source. As the controller 308, 408 continues to cause this determined current to be provided to the sensor device 108, the circuit treats measurements of voltage as that from a constant-current type system. The voltage drop across the sensor device 108 can then be used to determine fluid speed (step 824). The use of a predefined operating window in this hybrid mode is advantageous because a lookup table or simple math can be employed to determine the fluid speed. The lookup table can be used since the sensor device 108 is being maintained within the predetermined temperature window and is being supplied a substantially constant current.

The controller 308, 408 monitors the changes in voltage across the sensor device 108. Additionally, the voltage supplied to the current source is maintained at a substantially constant value to ensure that the predetermined current is provided to the sensor device 108 (step 828). The method then returns to step 808 where the controller 308, 408 continues to cause the determined amount of current to be provided to the sensor device 108.

If at any point it is determined that measurement data is no longer required, the control voltage supplied to the current source can be reduced or zeroed to effectively let the anemometer rest. This rest period can be used to conserve power consumption and maximize the period of time that the anemometer system 100 can be used without having to replace batteries or the like. This is particularly useful in remote applications where access to the anemometer system 100 is limited or difficult. Moreover, the controller 308, 408 may control the timing of rest periods and sensing periods to further manage power consumption.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

What is claimed is:

1. A device for sensing a flow rate, comprising:
a current source;
a sensor device, wherein the sensor device is exposed to a flow of material, and wherein the sensor device is interconnected to the current source;
a controller, wherein the controller controls the current source to supply a selected amount of current to the sensor device, wherein the selected amount of current is a constant, wherein a temperature of the sensor device varies with at least a rate of the flow of material, and wherein a voltage drop across the sensor device varies with the temperature of the sensor device;
an analog to digital converter, wherein a signal indicative of the voltage drop across the sensor device is provided to the controller.

2. The device of claim 1, wherein the constant current amount is selected from a plurality of different constant current amounts.

3. The device of claim 1, wherein the current source includes an operational amplifier, wherein a non-inverting input to the operational amplifier is supplied with a reference voltage, wherein an output of the operational amplifier is controlled through controlling the non-inverting input so that a constant current is supplied to the sensor device.

4. The device of claim 3, wherein the sensor device is connected between the output and an inverting input of the operational amplifier, and wherein a change in the temperature of the sensor device for a given constant current supplied to the sensor device results in a change in the voltage present at the output of the operational amplifier.

5. The device of claim 4, further comprising:
a digital to analog converter, wherein a voltage at the non-inverting input of the operational amplifier is provided by the digital to analog converter, and wherein a digital input of the digital to analog converter is interconnected to an output of the controller;
wherein a voltage at the output of the operational amplifier determines a digital output of the analog to digital converter, and wherein the digital output of the analog to digital converter is interconnected to an input of the controller,
wherein a voltage drop across the sensor device can be determined by the controller.

6. The device of claim 1, further comprising:
a plurality of sensor devices;
a plurality of flow shields, wherein at least some of said flow shields are oriented in different directions, wherein at least one flow shield is associated with at least one of said plurality of sensor devices, wherein information regarding a direction of flow relative to the device can be obtained from differences between the temperatures of the sensor devices associated with flow shields and the orientation of the flow shields.

7. The device of claim 6, wherein at least one of said flow shields blocks all ambient flow with respect to one of the plurality of sensor devices to obtain a signal indicative of zero-flow rate at ambient temperature.

8. The device of claim 6, wherein at least one of the plurality of sensor devices is not associated with a flow shield.

9. The device of claim 1, wherein the sensor device comprises a semiconductor device.

10. The device of claim 9, wherein the semiconductor device comprises at least one of a diode and a transistor.

11. The device of claim 1, wherein in a first mode of operation the controller maintains the current provided by the current source at a constant value and where in a second mode of operation the controller maintains the current provided by the current source at a constant value while ensuring that the sensor device is operating within a predefined operating temperature window.

12. The device of claim 11, wherein the relative configuration of the current source, sensor device, controller, and analog-to-digital converter is the same in the first and second modes of operation.

13. The device of claim 11, wherein in a third mode of operation the controller allows the current provided by the current source to vary in order to ensure the sensor device continues to operate at a predetermined temperature.

14. The device of claim 13, wherein the relative configuration of the current source, sensor device, controller, and analog to digital converter is the same in the first, second, and third modes of operation.

15. A method for sensing a flow rate of a medium, comprising:
exposing a flow sensor device to an ambient flow of a medium;
supplying a constant current to the flow sensor device;
determining a voltage drop across the flow sensor device while supplying the constant current to the flow sensor device, wherein an amount of the voltage drop is indicative of the flow rate of the medium, and wherein a temperature of the sensor device is allowed to vary with at least a rate of ambient flow of the medium.

16. The method of claim 15, further comprising:
shielding a reference sensor device from an ambient flow originating from a first range of directions in a first plane;
shielding the flow sensor device from an ambient flow originating from a second range of directions in the first plane;
supplying a constant current to the reference sensor device;
determining a voltage drop across the reference sensor device while supplying the constant current to the reference sensor device;
shielding a third sensor device from an ambient flow originating from a third range or directions in the first plane;
supplying a constant current to the third sensor device;
determining a voltage drop across the third sensor device while supplying the constant current to the third sensor device;
determining from the relative voltage drops across the flow, reference, and third sensor devices a direction of flow of the medium in the first plane.

17. The method of claim 16, wherein the quantity of the constant current supplied to the flow, reference, and third sensor devices is the same.

18. The method of claim 16, further comprising:
exposing an unshielded sensor device to ambient flow originating from any direction in the first plane;
supplying a constant current to the unshielded sensor device;
determining a voltage drop across the unshielded sensor device while supplying the constant current to the unshielded sensor device, wherein an amount of the voltage drop across the unshielded sensor is indicative of an absolute flow rate of the medium.

19. The method of claim 18, further comprising:
completely shielding a sensor device from an ambient flow;
supplying a constant current to the completely shielded sensor device, wherein an amount of the voltage drop across the completely shielded sensor is indicative of sensor voltage drop at zero-flow speed at ambient temperature.

20. The method of claim 15, further comprising:
supplying the constant current at a first current amount;
determining a first voltage drop across the flow sensor device while supplying the first current amount;
supplying the constant current at a second current amount;
determining a second voltage drop across the flow sensor device while supplying the second current amount;
selecting a current amount based on a comparison of the first and second voltage drops, wherein the constant current supplied to the flow sensor device is the selected current amount.

21. The method of claim 15, further comprising:
selecting an operating temperature window for the flow sensor device to operate within;
selecting the constant current to be supplied to the flow sensor device based on the selected operating temperature window; and
causing the selected constant current to be supplied to the flow sensor device as long as the flow sensor device operates within the selected operating temperature window.

22. A device for sensing wind speed, comprising:
a plurality of means for sensing wind speed in a first plane;
means for supplying a constant current to the plurality of means for sensing wind speed in the first plane;
means for determining a relative voltage drop across the means for sensing wind speed in the first plane;
means for outputting a signal indicating a wind speed and direction based on the relative voltage drop.

23. The device of claim 22, wherein the means for supplying constant current monitors current through at least one fixed resistance to ensure that the constant current is supplied to the plurality of means for sensing wind speed in the first plane.

24. The device of claim 22, further comprising means for determining an ambient air temperature, wherein the signal indicating the wind speed and direction is has been compensated for the ambient air temperature.

25. The device of claim 22, wherein the plurality of means for sensing wind speed in a first plane comprise at least one of a semiconductor diode and semiconductor transistor and wherein the means for supplying a constant current comprises an operational amplifier.
